(19) United States
(12) Patent Application Publication
(10) Pub. No.: US 2006/0096172 A1
(43) Pub. Date: May 11, 2006

(54) C-shaped tree and plant watering pail

(76) Inventor: Joseph Scott Powell, Wellington, OH (US)

Correspondence Address: Joseph Scott Powell, 19520 Diagonal Rd, Wellington, OH, 44090, US

(21) Appl. No.: 10/983,792

(22) Filed: Nov. 9, 2004

(51) Int. Cl. A01G 29/00

(52) U.S. Cl. 47/48.5

(57) ABSTRACT

A C-shaped tree and plant watering pail which can be fitted around a plant stem or the trunk of a tree and holds water which is slowly released into the soil through a porous bottom section. A removable flexible cover can be placed over the porous bottom section to allow the pail to retain its water. In a preferred embodiment the pail has a water reservoir between two concentric side walls with a hollow center section and a vertical slice missing from the pail walls which gives it a C-shape as viewed from above or below. In another embodiment a section is removed from the top of the C-shaped reservoir leaving the missing vertical slice extend from the bottom up only part way to the top.

### FEDERALLY SPONSORED RESEARCH

N/A. No federally sponsored research or development was involved with this design or application.

### BACKGROUND OF THE INVENTION

(1) Field of the Invention

This invention pertains to plant and tree watering apparatus. It would fall under US patent classification 47 subclass 65.5 indented subclass 79 irrigator—“Device for supplying water or water vapor to the soil and roots . . . ” or subclass 48.5—‘Apparatus and devices of container adapted to contain water discharged into the soil by means of some special feature of the device.’

(2) Description of Related Art

Related prior art is disclosed in the enclosed USPTO form SB08. Various devices are known in the art for placement around the trunk of a tree or plant to facilitate watering. U.S. Pat. No. 6,601,339, dated Aug. 5, 2003 to Parker describes a plant watering system with a base which has a periphery. The base also has a central hole with a slot between the central hole and the periphery. The base has interior and exterior walls which extend upwardly from the base and a pair of walls extends upwardly from the base on both sides of the slot. U.S. Pat. No. 5,852,896 dated Dec. 29, 1998 to Flasch describes a container for growing a plant in soil, the soil within an area defined by an annular inner wall having an open top; the inner wall includes transverse holes around its circumference and up its length. U.S. Pat. No. 5,117,582 dated Jun. 2, 1992, to Cissel describes a tree irrigator utilizing a flexible tree encircling container which may receive a substantial volume of a tree irrigating liquid and which will slowly disperse the liquid to the tree over a period of time. U.S. Pat. No. 6,023,883, dated Feb. 15, 2000, to Bacon describes a drip irrigator which is fitted around the trunk of a tree and holds a supply of water which slowly percolates into the soil to maintain irrigation of the tree roots, particularly during hot or dry weather. A “Tree Surrounding Ring” for protecting the trunk of a tree and enhancing the appearance of the tree, is detailed in U.S. Pat. No. 2,782,561, dated Feb. 26, 1957, to Robert A. Smith. The ring is interrupted by a ring slot or formed from two semicircular sections to facilitate fitting the ring around the trunk of the tree. In one embodiment, a U-shaped channel is shaped in the ring for receiving a flower bed. U.S. Pat. No. 2,909,328, dated Oct. 20, 1959, to George H. Babyak, describes an “Irrigating Coping For Gardens” including multiple, accurate coping segments which are fastened together end-to-end in surrounding relationship to the trunk of a tree. The confluent, assembled coping segments are filled with water by means of a garden hose which is removeably inserted in one of the segments, and the water percolates through multiple openings provided on the interior surfaces of the coping segments to irrigate the ground adjacent to the tree. U.S. Pat. No. 4,336,666, dated Jun. 29, 1982, to Adolph Caso, describes “Plant Waterers”, each characterized by a water reservoir formed with a slot to permit placement of the reservoir around the base of a plant and having hollow, perforated, water-dispensing spikes for insertion in the ground. The reservoir includes top and bottom ring sections and is formed with a covered aperture, through which the water may be replenished without having to remove the ring from operative position around the plant.

### BRIEF SUMMARY OF THE INVENTION

The invention is an improvement to the typical water pail. The invention retains a water reservoir, a handle, and a spout from a typical pail. An improvement is a C-shaped water reservoir making a hollow center section to the pail and a vertical slot the length of the pail. An improvement is also a porous bottom of the water reservoir. The hollow center section and the vertical slot allow the pail to be placed around small trees and plants so as to align generally with the natural drip line of their foliage. The porous bottom of the water reservoir allows irrigation water to slowly release into the soil near the natural foliage drip line of the small trees or plants.

### BRIEF DESCRIPTION OF THE DRAWINGS

The invention is better described by reference to the accompanying drawings, wherein:

FIG. 1 is a perspective view of the preferred C-shaped tree and plant watering pail embodiment;

FIG. 2 is a perspective view of an alternative C-shaped tree and plant watering pail embodiment.

### DETAILED DESCRIPTION OF THE INVENTION

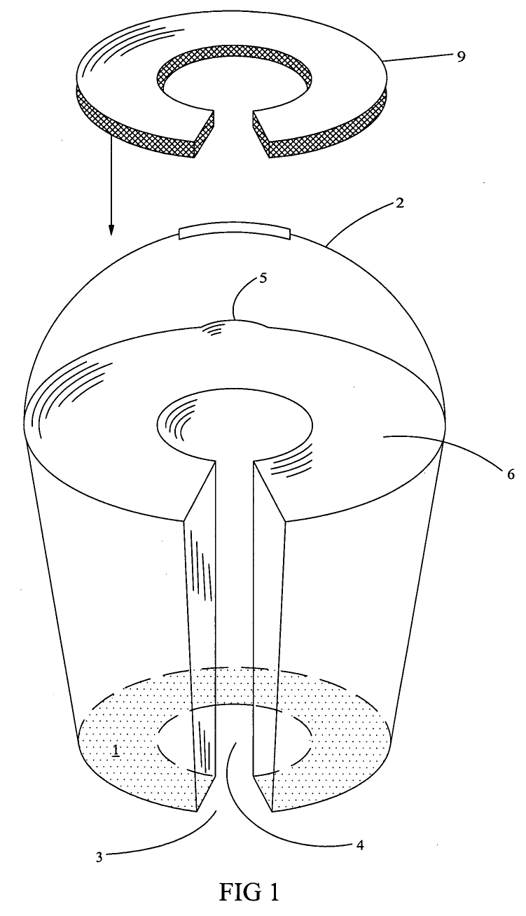

Referring to FIG. 1 of the drawings, a C-shaped tree and plant watering pail, hereafter referred to in this detailed description as “the invention,” can be seen. The invention retains a handle 2, a spout 5, and a water reservoir 6 all of which are typically present on a water pail. However, running the vertical length of the invention's water reservoir 6 is a slot 3. This slot 3 is the opening which gives the invention its C shape as viewed from above or below. Also, interior to the invention's water reservoir 6 is a hollow center 4 with no top or bottom. The wall of this hollow center 4 provides the inner wall of the invention's water reservoir 6. It is the combination of the vertical slot 3 and the hollow center 4 that allows placement of the invention around small trees or plants by horizontally sliding the slot 3 past the tree trunk or plant stem until the hollow center 4 encircles the tree trunk or plant stem. The diameter of the invention, and thus its porous bottom 1, along with the width of the vertical slot 3 can be manufactured in various sizes to accommodate a range of tree trunk and plant stem sizes. The various sizes of the invention also allow the porous bottom 1 to be placed generally below the natural foliage drip line of the tree or plant. As the invention sits on the ground around the tree, water slowly seeps out the porous bottom 1 of the water reservoir 6. The combination of the slow water release, or seepage, from the porous bottom 1 and its placement generally beneath the tree or plant natural foliage drip line provide optimum irrigation for small trees or plants. The flexible cover 9 can be inserted into the pail to cover the porous bottom 1 to allow conventional use of the invention as a typical water pail. The flexible cover can be removed to allow use of the invention as the above described C-shaped tree and plant watering pail.

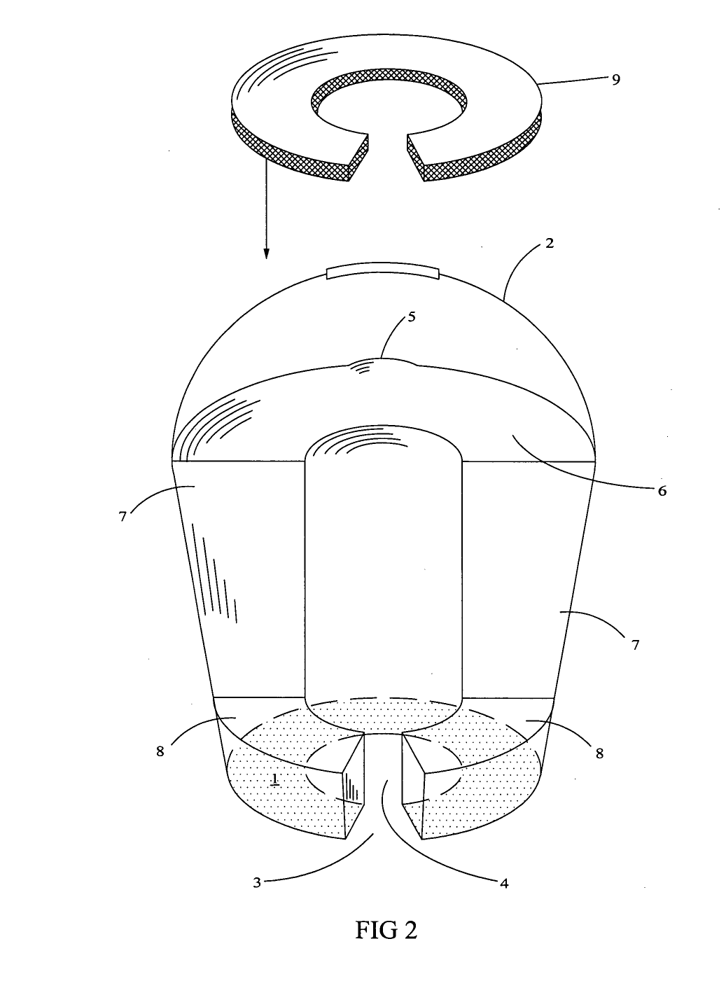

Referring next to FIG. 2 of the drawings, another embodiment of the invention is shown. This embodiment consists of the same parts as in FIG. 1 with the addition of two vertical reservoir walls 7 and two horizontal walls 8. An upper section of the water reservoir 6 as shown in FIG. 1 has been removed and the resulting open spaces have been replaced with two vertical walls 7 and two horizontal walls 8. This serves to enclose the water reservoir 6 except for the open top and give the invention the appearance of a half pail in its upper area. A small section near the porous bottom 1 remains as in FIG. 1 thus keeping the water reservoir's 6 C-shape. The removed upper section of the water reservoir 6 allows for easier placement of the invention around bushy or branchy trees and plants.

I claim:

1. An improvement to a typical water pail consisting of conventional features of a water reservoir, a pour spout, and a handle wherein the improvement comprises
a C-shaped water reservoir,
a hollow center section,
a porous bottom,
a removable, flexible cover for the porous bottom,
which will give the pail a unique new use as a C-shaped tree or plant watering pail which provides passive slow-release irrigation at or near the tree or plant natural foliage drip line.

2. A pail as in claim 1 in which the water reservoir is C-shaped as viewed from above or below with a vertical slice missing from the pail walls.

3. A pail as in claim 1 in which the center section of the pail is hollow with no top or bottom so as to allow placement around the tree or plant, on the soil.

4. A pail as in claim 1 in which the bottom of the C-shaped water reservoir is porous so as to allow slow release of water into the soil.

5. A pail as in claim 1 in which a removable and flexible cover allows the pail to hold water when inserted and allows the pail to leak water through the porous bottom when removed.
